(19) United States
(12) Patent Application Publication
(10) Pub. No.: US 2019/0035253 A1
(43) Pub. Date: Jan. 31, 2019

(54) Wireless Gas Detection Sensor

(71) Applicant: DETCON, INC, Dallas, TX (US)

(72) Inventors: Kenneth A. Jones, II, Atascocita, TX (US); Leonard B. Urbanovsky, Houston, TX (US); Lance J. Toups, Larose, LA (US); Robert J. Masi, The Woodlands, TX (US)

(21) Appl. No.: 16/077,133

(22) PCT Filed: Feb. 8, 2017
(86) PCT No.: PCT/US17/16974

§ 371 Date: Aug. 10, 2018

Related U.S. Application Data
(60) Provisional application No. 62/294,528, filed on Feb. 12, 2016.

(51) Int. Cl. G08B 21/14; G08B 25/10

(52) U.S. Cl. CPC G08B 21/14; G08B 25/10

(57) ABSTRACT

A gas sensing device (10) (100) and method are provided. The battery-powered wireless gas sensing device (10) (100) has low power consumption components and power-saving functions. The gas sensing device (10) (100) has extended battery life and run times so as not to require battery replacement or recharging prior to expiration of the standard gas sensor calibration cycle.

### TECHNICAL FIELD

The disclosure relates generally to battery-powered, wireless gas sensing devices, and more particularly to battery-powered, wireless gas sensing devices having low power consumption components and power-saving functions that effectively extend battery life and run times.

### BACKGROUND

Gas detectors are commonly known devices that are used to sense the presence of smoke or harmful gases in gaseous atmospheres. Such gas detectors may be portable devices that are transported, for example, by firefighters or other investigators into selected locations for monitoring the concentration of selected gases, or they may be fixed devices, for example, devices used for detecting toxic or combustible gases in extreme conditions that could be harmful to investigators. Transportable gas detectors are generally wireless devices, whereas fixed gas detectors may be either hard wired or wireless.

Wirelessly enabled detectors have many advantages over hard wired detectors, including the ability to broadcast gas sensor data and alarms in real-time, thereby improving situational awareness and reducing incident response times; the ability to easily transmit gas detection information to multiple devices connected in a network; and, if desired, the ability to build all necessary gas detection components into a small, lightweight, portable device. Eliminating the need for wiring devices is particularly advantageous for industrial gas detection applications where sophisticated systems incorporating multiple different detection devices (fixed and/or transportable) are often needed. In this regard, industrial gas detection needs are often spread out over a very wide area and involve multiple types of hazards in varied conditions. Industrial systems configured to detect multiple or even single hazards often involve a combination of various detection technologies, including electrochemical sensors for toxic gases, solid-state metal oxide silicon sensors for hydrogen sulfide, catalytic beads for combustible gases and infrared detectors for combustible hydrocarbons, and proper system performance requires monitoring information from all such devices collectively. Point-to-point wiring among such devices is impractical, but such sophisticated systems can be effectively implemented through wireless communication.

Accordingly, whether fixed or transportable, gas detecting devices today are predominantly wireless. However, unlike hard wired systems, wireless detectors are necessarily battery powered, which begets the disadvantages of increased device weight, the obligation of monitoring diminishing battery life and the need to replace or recharge the battery as necessary. This is a particular concern in the art of wireless gas detectors, because gas sensing elements within the devices must be periodically calibrated and it is important for the battery to last for the entire calibration cycle. In this regard, gas sensors are typically calibrated on 12-month intervals, so it is important for a battery to power the device for at least this interval to avoid the need for additional maintenance.

One straight forward means of ensuring sufficient battery life is to use a large battery. However, this is generally not a practical solution for transportable devices, which are often intended to be carried by individuals and used as personal protection devices. Using larger batteries is also not practical when the device is intended for use in hazardous locations where the battery must be enclosed in an explosion proof enclosure. Another approach for extending battery life is through controlling the functionality of the detector device to minimize power consumption, such as by limiting the wireless transmission of gas concentration information to only report when a hazardous condition is met and/or by only transmitting an “all clear” signal at long intervals, e.g., 1 minute or more. However, this approach is unacceptable because there is no reliable method for determining that the gas sensing element is still properly functioning, and real-time detection of hazardous gases is often a critical factor in preserving life and property.

Accordingly, there is a need in the art for an improved wireless gas detector having enhanced battery life without substantially increasing battery size and/or device weight, and without sacrificing real-time gas detection functionality.

### SUMMARY

In accordance with one aspect of the disclosure, a gas sensing device having high power consumption active modes, a low power consumption passive mode and an off mode is provided. The gas sensing device includes a gas sensor module having a gas sensing element. The gas sensing element continuously monitors at least one of the presence and concentration of at least one gas in a gaseous atmosphere during the active modes and the passive mode, and continuously generates corresponding gas concentration information. The gas sensor also includes a wireless communicator and a processor operably connected to the gas sensor module and the wireless communicator. The processor is configured to actively communicate during the active modes, be inactive when in the low power consumption passive mode, retrieve the gas concentration information from the gas sensor module, and transmit the information to the wireless communicator. The gas sensing device also includes a power supply electrically connected to each of the gas sensor module, the processor and the wireless communicator. The wireless communicator is configured to receive the gas concentration information from the processor and to wirelessly transmit the information to at least one information receiver.

In one embodiment of this aspect, the gas concentration information is real-time gas concentration information. In another embodiment of this aspect, the gas sensing element is a nondispersive infrared gas sensor. In still another embodiment of this aspect, the gas sensing device has a maximum average power consumption of about 17 mWh. In yet another embodiment of this aspect, the power supply is a battery having a capacity of at least 342 watt-hours and a run time of at least 24 months.

In another embodiment of this aspect, the gas sensing element is an electrochemical gas sensor. In still another embodiment of this aspect, the gas sensing device has a maximum average power consumption of about 11 mWh. In still yet another embodiment of this aspect, the power supply is a battery having a capacity of at least 342 watt-hours and a run time of at least 36 months.

In another embodiment of this aspect, the wireless communicator is a radio frequency module that wirelessly communicates with at least one external device selected from the group consisting of Wi-Fi/wireless; FM radio links; wireless personal area network, WPAN, protocols; Microsoft™ DirectBand network; Wibree™; WirelessHART; Ultra-wideband, UWB; ISA-SP100 standards; Zigbee®; IEEE 802.15.4-based protocols; IEEE 802.11 family of WLAN protocols; and RFID signaling protocols. In still another embodiment of this aspect, a display is electrically connected to the processor in which the display periodically displays the gas concentration information and displays information communicated from the processor when the processor is activated by a user input command In another embodiment of this aspect, the gas sensing device further includes at least one integrated user input module for entering user input commands.

In still another embodiment of this aspect, the processor is configured to execute firmware that is programmed to perform a plurality of functions. The functions include checking gas concentration information generated by the gas sensing element, communicating gas concentration information to the wireless communicator; checking a status of the power supply, responding to user input commands entered through an integrated user input module, responding to external requests for information that are communicated to the device through the wireless communicator and directing the display of information related to any of said functions on a display. In accordance with another embodiment of this aspect, the processor executes each of the functions once per second.

In accordance with another aspect, a method for continuously monitoring at least one of the presence and concentration of at least one gas in a gaseous atmosphere is provided. The method includes providing a gas sensing device configured for operation in high power consumption active modes, a low power consumption passive mode and an off mode. The provided device has a gas sensor module comprising a gas sensing element, a processor operably connected to the gas sensor module, a wireless communicator operably connected to the processor and a power supply electrically connected to each of the gas sensor module, the processor and the wireless communicator. The processor is configured to actively communicate during the active modes and be inactive when in the low power consumption passive mode. The method further includes continuously monitoring at least one of the presence and concentration of the at least one gas in a gaseous atmosphere with the gas sensing element when the device is in the active mode or the passive mode, actively checking gas concentration information generated by the gas sensing element and actively communicating the gas concentration information from the processor to the wireless communicator.

In an embodiment of this aspect, the gas sensing device communicates gas concentration information in real-time, and the processor executes at least one of the continuously monitoring, actively checking and actively communicating steps once per second.

In another embodiment of this aspect, the gas sensing element is a nondispersive infrared gas sensor. In still another embodiment of this aspect the gas sensing device consumes a maximum average power consumption of about 17 mWh.

In yet another embodiment of this aspect, the gas sensing element is an electrochemical gas sensor. In still another embodiment of this aspect, the gas sensing device consumes a maximum average power of about 11 mWh.

In another embodiment of this aspect, the wireless communicator is a radio frequency module that wirelessly communicates with at least one external device up to once per second. In another embodiment of this aspect, the method further includes wirelessly signaling an external alarm generating apparatus to produce an alarm.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a simplified block diagram showing an example hardware embodiment of a gas sensing device of the disclosure;

FIG. 2 is a hardware block diagram of a gas sensing device configured to operate using a wireless protocol and including additional optional components as compared with the simplified diagram of FIG. 1;

FIG. 3 is block diagram of processor firmware economizing the system power operations using the wireless protocol; and

FIG. 4 is a flowchart of an example monitoring process.

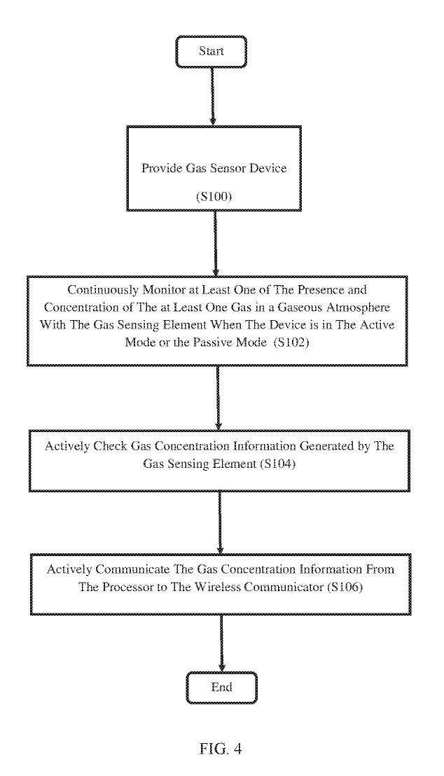

### DETAILED DESCRIPTION

The disclosure provides fixed or transportable gas sensing devices that use gas sensing plug-in modules that sense one or more selected gases and produce the working signals for communicating information to integrated and/or external alarm generators. The sensor modules use low power and enable an overall ultra-low power detector design. The devices are capable of continuous operation and consume an extremely low amount of power during operation so as to substantially extend the battery run time. The devices are particularly useful in the form of compact, field portable gas detection instruments.

The detector of the disclosure achieves such ultra-low power performance by including numerous low-power hardware circuits as well as power saving firmware techniques. In this regard, efficient wireless communication protocols, as described below, are used. In one type, for example, wireless communication modules operate using wireless sensor networking technology that utilizes a time synchronized, self-organizing, and self-healing mesh architecture and use the 2.4 GHz ISM band to transmit real time data using IEEE 802.15.4 standard radios. These, as others, are preferred because they operate with very low power consumption. However, the gas sensing device may alternatively be configured to operate using any other wireless protocol capable of wirelessly transmitting and/or receiving radio signals using modulation techniques, data encoding, and/or frequencies, with the minimization of data transmission time to reduce power consumption. Examples of wireless communication non-exclusively include the Wi-Fi/wireless Ethernet standards (802.11a/b/g/n/s), frequency modulation (FM) radio links, WPAN (wireless personal area network) protocols (e.g., 802.15.4), the Microsoft™ DirectBand network, Wibree™, WirelessHART, Ultra-wideband (UWB), the ISA-SP100 standards maintained by the Instrument Society of Automation (ISA) such as SP100.11a, Zigbee® IEEE 802.15.4-based protocols, the IEEE 802.11 family of WLAN (wireless local area network) protocols, known RFID (radio frequency identification) signaling protocols, or any other suitable wireless communication protocol as would be determined by one skilled in the art. For example, transmission via Bluetooth technology is possible but with a limited transmission range.

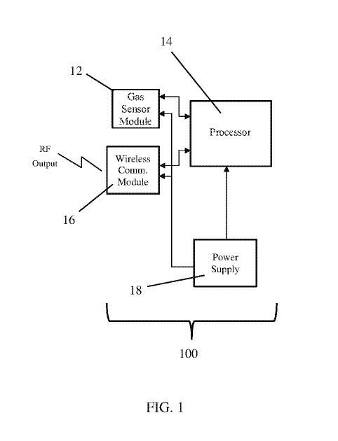

Referring now to the drawings figures, where like reference designators refer to like elements, there is shown in FIG. 1, example hardware components of a gas sensing device 10 of the invention. The gas sensing device 10 includes at least one gas sensor module 12, a processor 14, a wireless communicator 16 and a power supply 18.

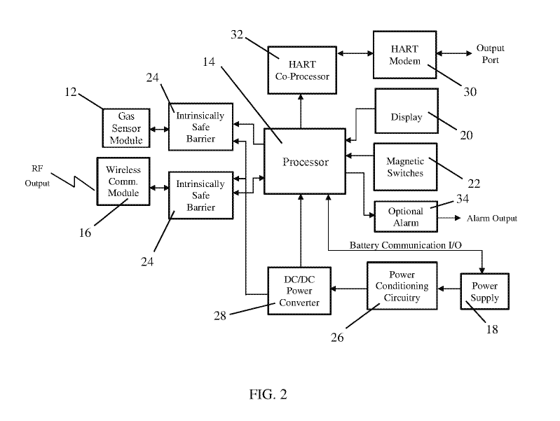

Illustrated in FIG. 2 is a more detailed embodiment of a gas sensing device 100 of the disclosure that includes components in addition to those shown with respect to the gas device 10 of FIG. 1 that further optimize the performance of the gas sensing device as compared with existing devices, particularly wherein the gas sensing device 100 is configured to operate using the wireless protocol.

The gas sensor module 12 may generally be any gas sensor module incorporating at least one gas sensor element that continuously monitors the presence and/or concentration of at least one gas in a gaseous atmosphere and continuously generates corresponding gas concentration information, as well as the necessary circuitry for communicating said gas concentration information to the processor. Suitable gas sensor modules are widely commercially available and non-exclusively include both electrochemical gas sensors and nondispersive infrared (NDIR) sensors. Electrochemical sensors are used to measure a wide range of toxic gases, including but not limited to hydrogen sulfide, sulfur dioxide, chlorine, hydrogen cyanide, hydrogen chloride, nitric oxide, nitrogen dioxide, ethylene oxide, phosphine, carbon monoxide, ozone and ammonia. NDIR sensors are used to measure combustible hydrocarbon gases, including but not limited to methane, ethane, propane, butane, hexane, pentane, ethylene, propylene and hydrogen. Other gas sensor types could be used herein but not necessarily with similar low power consumption functionality as electrochemical or NDIR sensors. For example, metal oxide semiconductor sensors or catalytic sensors could be effectively used in the disclosed gas sensing apparatus but they are generally high power consumption devices.

The processor 14 is operably connected to the gas sensor module through standard control circuitry carried on or embedded in one or more printed circuit boards, as is known in the art of gas sensor devices, which connect the processor to the circuitry of the gas sensor module 12. As schematically illustrated in FIG. 2, the control circuitry connecting the processor 14 to the gas sensor module 12 is provided with intrinsic safety protection that limits the energy available to the module under both normal operation and fault conditions, thereby allowing it to operate in an explosive atmosphere without the risk of causing an explosion. Intrinsic safety protection may be provided by any conventional means in the art. In one embodiment, an intrinsically safe barrier 24, such as a Zener barrier, is positioned between the power supply 18 and the gas sensor module 12, in one embodiment preferably between the processor 14 and the gas sensor module 12 as shown in FIG. 2. Any intrinsically safe barrier may be used and such is not limited to Zener barriers. Additionally, rather than using an intrinsically safe barrier for the gas sensor module 12, the sensor cell itself may be placed in an explosion-proof housing, but this will prevent the changing of the sensor cell while it is installed in a hazardous location, and explosion-proof housings use sintered flame arrestors that slow the overall response time of the gas sensing element, which is not ideal, particularly in a device where real-time gas concentration readings are desired.

The processor 14 may be a microprocessor. The processor 14 is configured to execute commands and instructions and implementing the functions described herein. The processor 14 includes a memory and firmware stored in the memory. The firmware includes the programmed instructions for how to operate the gas sensing device 10 and 100, and which firmware is programmed to optimize power conservation during operation, as discussed in greater detail below. The processor fetches and executes these firmware instructions. The processor memory is typically composed of a combination of random-access memory (RAM) for temporary information storage and processing, and non-volatile memory (flash, read-only memory (ROM), programmable read-only memory (PROM), etc.) that contains permanent aspects of the firmware, i.e. the basic operating instructions of the device, including operation of sensor element, retrieving and processing gas concentration information therefrom, transmitting the gas sensor information to a wireless communicator module 16, optionally displaying the gas sensor information on an integral display 20 (illustrated in FIG. 2), and directing the wireless communicator to transmit gas concentration information to one or more external devices (not shown).

Processors 14 operating the gas sensing device 10 and 100, such as for example without limitation, microcontrollers, general purpose processors, application specific integrated circuits (ASIC), application-specific instruction set processors (ASIP), digital signal processors (DSP), programmable logic devices such as field-programmable gate arrays (FPGA), programmable logic devices (PLD) and programmable logic arrays (PLA) provide ultra-low power consumption characteristics, including: (1) the ability to put the processor into an inactive mode when code execution is not needed (processor peripherals can be disabled to save power); (2) Internal timers and interrupts to put the processor in active mode when needed; (3) Clock mode can be adjusted to save power when full clock speed is not needed; (4) Active currents down to 150 μA/MHz, inactive currents down to 10 nA; and (5) 80% of instructions are single cycle. This allows the processor 14 to execute the code faster and limits the active time. Particularly useful herein are 16 or 32 bit microcontrollers.

In preferred embodiments, the processor 14 is contained within an intrinsically safe and/or explosion-proof housing so that the processor 14 cannot explode or become an ignition source in a flammable atmosphere. An explosion proof housing is a housing that has been engineered and constructed to contain a flash or explosion. Such housings are usually made of cast aluminum or stainless steel and are of sufficient mass and strength to safely contain an explosion should flammable gases or vapors penetrate the housing and the internal electronics or wiring cause an ignition. The design should also prevent any surface temperatures that could exceed the ignition temperature of combustible gases or vapors in the surrounding atmosphere, and should avoid static build-up on the outer housing surface that could potentially ignite combustible gases in the surrounding atmosphere.

Like the gas sensor module, the wireless communicator 16 is also operably connected to the processor 14 through standard control circuitry carried on or embedded in one or more printed circuit boards, as is known in the art. In one embodiment, the wireless communicator 16 is preferably a radio frequency (RF) module capable of communicating using the wireless protocol for one way or bi-directional wireless communication. The wireless communicator 16 can transmit and/or receive an RF signal from a remote device or location. Most preferably, the wireless communicator 16 is an RF wireless transceiver capable of operating and transmitting data in accordance with the wireless protocol.

The wireless communicator 16 is provided as a removable or non-removable module and may be configured as an adapter to retrofit an existing transmitter. The wireless communicator 16 can be directly powered with power received directly from an attached power source, e.g., through a conventional two-wire process control loop, or can be powered with power received from a process control loop and stored for subsequent use. Like the processor 14, the wireless communicator 16 is preferably contained within an intrinsically safe housing, and most preferably processor 14 and wireless communicator 16 are contained within the same intrinsically safe housing. Alternatively, rather than containing the wireless communicator 16 within an intrinsically safe housing, the wireless communicator 16 may be provided with intrinsic safety protection by placing an intrinsically safe barrier 24 between the power supply 18 and the wireless communicator module 16, most preferably between the processor 14 and the wireless communicator module 16, as shown in FIG. 2, like the protection provided for the gas sensor module 12. When the wireless communicator 16 is an RF radio module having an antenna, the antenna should be outside the housing in free air to allow RF transmissions to network devices. Additionally, the RF output from the radio can be protected with an intrinsically-safe barrier, such as by using an isolator, instead of protecting the radio itself, but this will reduce the RF transmission distance.

Another component of the gas sensing device 10 and 100 of the disclosure is a power (current) supply 18. The power supply 18 is electrically connected to each of the gas sensor module 12, the processor 14 and the wireless communicator 16, as well as all other electrically connected components of the gas sensing device. For a non-wired fixed or transportable device as particularly intended herein, the power supply 18 is a direct current (DC) power supply. The DC power supply may comprise one or more batteries, one or more solar panels, or another suitable power source. Preferably, the DC power supply 18 is a replaceable battery pack that is either rechargeable (containing rechargeable cells) or non-rechargeable (containing non-rechargeable, disposable cells). Whether rechargeable or non-rechargeable, the battery packs use the same connectors and are preferably physically the same size so they can be used interchangeably in the sensor assembly. Preferred battery types are rechargeable lithium-ion batteries or non-rechargeable lithium batteries, although any conventional battery type may be used, non-exclusively including rechargeable and non-rechargeable alkaline batteries, nickel-zinc batteries, nickel-metal hydride batteries and nickel cadmium batteries. The batteries may have any desired capacity without limitation, but consideration should be taken for battery weight, particularly if the gas sensing device is intended to be portable, and battery size, particularly if the gas sensing device is intended to be used in a hazardous atmosphere that would require it to be held in an explosion proof housing.

When a rechargeable battery pack is used, the pack can be removed from the assembly and recharged in a charging station or with another external power source, or it can be recharged while installed, such as by using a solar panel or other power charging source. The sensing device may alternatively be powered by an external power source rather than a battery, wherein a battery may optionally serve as a power back-up if the external power fails. In this embodiment, the external power source may also recharge the battery while it powers the device.

As mentioned above, FIG. 2 shows a more detailed embodiment of a gas sensing device 100 of the disclosure that includes additional components that further optimize the performance of the gas sensing device 10 of FIG. 1, particularly wherein the gas sensing device 100 is configured to operate using the wireless protocol.

As illustrated in FIG. 2, the power supply 18 may be connected to the sensing device through power conditioning circuitry 26 and one or more DC/DC power converters 28. The power conditioning circuitry 26 protects the internal electronic circuitry of the gas sensing device by removing any potentially harmful power transients from the battery or other external power source, such as by using transient suppression diodes, current limiting fuses, series resistors and bypass capacitors. The DC/DC power converter 28 converts the voltage supplied by the battery, solar panel, or other external source to a low voltage, preferably in the range of from about 1.8V to about 5.0V, that can be used by the processor 14, sensor module 12, wireless communicator module 16 and any other connected, electrically powered module. DC/DC power converters are conventionally known in the art and are commercially available. A suitable converter useful herein could be readily determined by one skilled in the art. Preferred are high efficiency DC/DC power converters that prevent wasted power to maximize battery life.

Gas sensing devices 100 further incorporate a display 20 for displaying the real-time gas level being read by the sensor element. For example, if the gas concentration being read by the sensor is over a certain pre-set value, e.g. 5% concentration, the processor 14 instructs the display 20 to show the numerical gas level or another pre-selected alert or alarm designator. If the gas concentration level is below the pre-set value, the processor instructs the display to flash a period (“.”) to indicate that the sensor is still active and functioning properly. In preferred embodiments, the display 20 is a light-emitting diode (LED) display, which is preferred because its functions with very low power consumption. However, any type of conventionally known display may be used. For example, a liquid crystal display (LCD) may be used to reduce the power further, but it will not be visible at night without the addition of a power consuming backlight or at low temperatures without the addition of a power consuming heater element.

Some embodiments of the gas sensing devices 100 further incorporate a user input module, such as magnetic switches 22, which are preferably integrated or embedded inside the sensor housing. Magnetic switches 22 function as a user input interface allowing a user to enter input commands to query the state of the device, i.e., request certain information from the processor 14 and view information responsive to the user request from the processor 14 with the display 20. For example, magnetic switches 22 may activate a menu wherein a user may check various status readings of the sensing device or control various device features. For example, the processor 14 may be programmed to allow the user to check the battery charge level through battery communication I/O signals sent between the processor 14 and the power supply 18 as illustrated in FIG. 2, or check a numerical value of the gas concentration, or any other pre-programmed function. The processor 14 may also be programmed to allow the user to change and/or view settings such as the RF channel, gas type (if the removable gas module is switched), alarm levels and sensor range. The processor 14 may also be programmed to allow for the gas sensing element to be calibrated, and may include calibration menus that allow the display of calibration instructions on the display 20. In a preferred embodiment, magnetic switches 22 comprise embedded magnetic reed switches that are activated from outside the sensor by a rare earth magnet. The processor 14 senses when the switch is activated and sends the appropriate information to the display 20. However, other types of switches may be used, including any contact or non-contact switch.

The final optional components illustrated in FIG. 2 are the wireless components, such as wirelessHART, of an optional modem 30 and co-processor 32. These optional components allow users to configure the gas sensing device 100 using a wired connection to a master device, which may be any suitable external device loaded with a suitable host application software, including devices such as a laptop, tablet, personal computer, handheld wireless configurators capable of executing a master protocol as determinable by one skilled in the art, and the gas sensing device 100 may or may not be connected to the wireless master device through an intermediary such as a access point and/or a gateway, and the like. The modem 30 has an output port for connecting a cable to the wireless master device (not shown) and receives instructions from the master device in the form of analog electrical signals. The modem 30 translates the analog electrical signal into digital information that can be received by the co-processor 32. The co-processor 32 manages the communications received from the modem, forwarding all requests for information from the modem 30 to the processor 14 for processing. The modem 30 also works in the reverse, translating digital information from the co-processor 32 into analog signals that conform to the protocol, which can then be transmitted through the wired connection back to the external master device. To conserve power, the modem 30 is powered off when no traffic is occurring at the output port.

In use, the gas sensing device has high power consumption active modes during which the processor 14 actively communicates with integrated device components, a low power consumption passive mode during which the processor 14 is an inactive, passive mode, and an off mode. The gas sensing element within the gas sensor module 12 continuously monitors the presence and/or concentration of at least one gas in a gaseous atmosphere during both the active modes and the passive mode, and continuously generates corresponding gas concentration information. The processor 14 retrieves the gas concentration information from the gas sensor module 12 and transmits the information to the wireless communicator 16. The wireless communicator 16 receives the gas concentration information from the processor 14 and wirelessly transmits the information to an external information receiver, which external receiver may include an external alarm generating apparatus, or to an integrated alarm generating apparatus 34 connected through standard control circuitry, if the gas concentration level exceeds a user pre-set threshold level. Whether external or integrated, the alarm may be an audible alarm, a visual alarm, or an alarm having both audio and visual components. Alternatively or in addition, the triggering of an alarm condition may alert an operator to the alarm condition via cellphone, e-mail or other form of wirelessly transmitted alert, as determinable by one skilled in the art.

Both the processor 14 and wireless communicator 16 are predominantly in ultra-low power modes and only spike in power consumption when actively functioning. Such active functioning includes when the wireless communicator 16 is actively transmitting or receiving information, or when the processor 14 is actively executing the firmware instructions. The active, high power functions of the processor 14 include: checking the status of the sensor cell (i.e., checking the gas concentration information generated by the gas sensing element to determine if any harmful gas is present); communicating gas concentration information updates to the wireless communicator 16 for external transmission to other devices in a connected network; responding to any external requests for information transmitted through the wireless communicator 16 or from a master device through the output port; checks for any requests from the co-processor; checking the status of the magnetic switches (or other user input module) to determine if a user is attempting to access the control/status menus, and responding to user input commands entered through the user input module; checking the status of the power supply (i.e., the estimated remaining run time of the rechargeable battery or the voltage level of the non-rechargeable battery or external supply); and updating the display 20 and alarm outputs, including directing the display 20 to display information related to any of the processor 14 functions.

After all of these tasks are completed, the processor goes back into a passive, ultra-low power mode to conserve power, during which the processor 14 uses almost no power. In the preferred embodiments, each of these functions of the processor 14 is executed no more than once per second. Likewise, the wireless communicator 16 will only go into full operational mode no more than once per second to conserve power. This prevents the wireless communicator 16 from consuming power while waiting for the receiving radio to prepare for or acknowledge transmissions from the wireless communicator 16 and limits the amount of time it is transmitting. The plug-in gas sensor module 12, however, is active even when the wireless communication module 16 and processors, e.g., the processor 14, are in their passive, low power modes. The LED display 20 of the sensing device is normally in a low power consuming passive mode to conserve power, merely flashing a “.” once every ten seconds (as noted above) to indicate it is still active and properly functioning. The firmware is programmed to cause the processor 14 to turn on the display 20 when the concentration is above 5% of the range of the sensor 12, but otherwise the display 20 remains in passive mode, unless activated by a user input with the magnetic (or other) switches 22. The firmware is also preferably programmed to cause the processor 14 to display a signal on the display 20 when there is a fault, such as commanding the display 20 to show a symbol such as “----” or any other desired indicator.

By optimizing the time during which the gas sensing devices 10 and 100 of the disclosure are in the low power consumption passive mode, the disclosed devices provide much longer battery run times than any existing gas detection sensor. As configured, the electrochemical version of the gas sensing device 10 and 100 has a maximum average power consumption of about 11 mWh and when connected to a battery having a capacity of 342 watt-hours, for example, can operate up to 36 months before requiring a battery change or recharge. The infrared version of the gas sensing device 10 and 100 has a maximum average power consumption of about 17 mWh and when connected to a battery having a capacity of 342 watt-hours, for example, can operate up to 24 months before requiring a battery change or recharge.

As discussed above, in industrial gas detection applications multiple different gas sensing devices (fixed and/or transportable) 10 and 100 are often needed to properly assess the presence of multiple types of hazards in a single location. Accordingly, the gas sensing device 10 and 100 of the disclosure may be just a single node within a more complex ad hoc or mesh network that includes a plurality of peer devices, wherein the gas sensing device 10 and 100 may optionally intercommunicate wirelessly with other gas sensing device 10 and 100. In this regard, such a network may include a plurality of gas sensing devices 10 and 100 of the disclosure, each preferably being configured to detect a different type of hazardous gas, and each of which is preferably configured with the capability of communicating with each other through their respective wireless communicators 16, preferably with each gas sensing device 10 and 100 utilizing the wireless protocol. The means through which the gas sensing device 10 and 100 can be configured to communicate with each other are commonly known in the art and include communication over a fixed frequency using a local area network (e.g., a ring topology) or other suitable network arrangement in which each device multicasts messages to all other devices in accordance with a communication protocol that allocates network time among the gas sensing device 10 and 100, or using other schemes for routing messages across mesh networks such as Ad Hoc On-Demand Distance Vector (AODV), Better Approach To Mobile Adhoc Networking (B.A.T.M.A.N.), Babel, Dynamic NIx-Vector Routing (DNVR), Destination-Sequenced Distance-Vector Routing (DSDV), Dynamic Source Routing (DSR), Hybrid Wireless Mesh Protocol (HWMP), Temporally-Ordered Routing Algorithm (TORA) and the 802.11s standards being developed by the Institute of Electrical and Electronic Engineers (IEEE). Each gas sensing device 10 and 100 within such a network may also be wirelessly connected to an external master device that is preferably capable of compiling data from all networked gas sensing device 10 and 100 collectively. Alternatively, one of the networked gas sensing device 10 and 100 themselves may be set up as a master device with a master node protocol with all other networked gas sensing devices 10 and 100 being configured as slave devices using a slave node protocol, as would be readily determined by one skilled in the art. The gas sensing devices 10 and 100 in the network may also have the ability to repeat the traffic from other gas sensing devices 10 and 100 to increase the overall transmission distance.

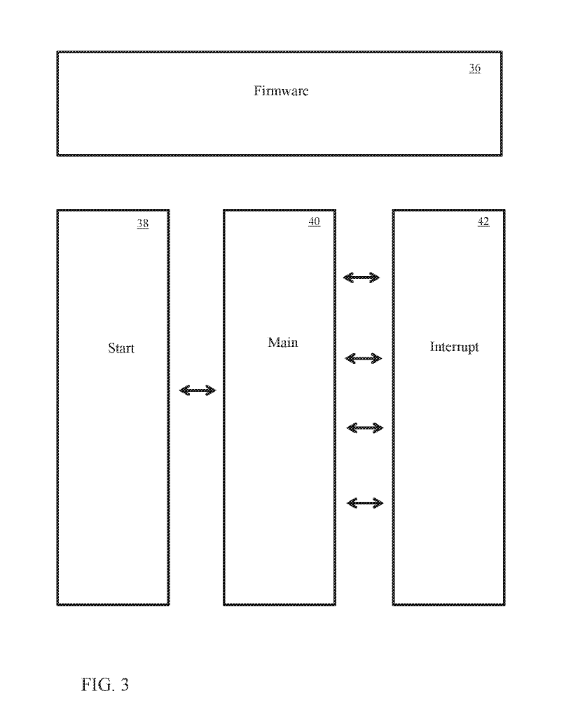

Referring to flow diagram of FIG. 3, in order to accomplish such optimized power conserving functionality, the firmware 36 for the processor 14 is programmed to include start 38 the main program functions 40 to economize power demands as illustrated. As shown in FIG. 3, the firmware 36 includes interrupts 42 and the main program functions 40. For example, the main process loop of the main program functions 40 calls all functions vital to obtaining data from the sensing device to monitor its status, create gas concentration information, and uses that concentration data to display a value on the LED display 20. Additional functions are called to handle various system events and cyclical timed tasks. The software program embodied in the firmware 36 causes the processor 14 to execute the power-saving functionality of the gas sensing device 10 and 100 such as interrupts of time keeping, receive and transmit, sleep function and change notification. As a priority event occurs or the timer has expired, the processor 14 “wakes up” to resume normal tasks as instructed.

Embodiments include:

1. A low power consumption gas sensing device, comprising:

a gas sensor module comprising a gas sensing element;

a processor operably connected to the gas sensor module;

a wireless communicator operably connected to said processor; and

a current source electrically connected to each of the gas sensor module, the processor and the wireless communicator;

wherein the gas sensing device has high power consumption active modes during which the processor actively communicates with integrated device components, a low power consumption passive mode during which the processor is inactive, and an off mode;

wherein the gas sensing element continuously monitors the presence and/or concentration of at least one gas in a gaseous atmosphere during the active modes and the passive mode, and continuously generates corresponding gas concentration information; wherein the processor is configured to retrieve said gas concentration information from the gas sensor module and to transmit said information to the wireless communicator; and wherein the wireless communicator is configured to receive said gas concentration information from the processor and to wirelessly transmit said information to one or more information receivers.

2. The gas sensing device of embodiment 1, wherein the gas concentration information is real-time gas concentration information.

3. The gas sensing device of embodiment 1, wherein the gas sensing element is a nondispersive infrared gas sensor.

4. The gas sensing device of embodiment 3, wherein the gas sensing device has a maximum average power consumption of about 17 mWh.

5. The gas sensing device of embodiment 4, wherein the current source is a battery having a capacity of at least 342 watt-hours and a run time of at least 24 months.

6. The gas sensing device of embodiment 1, wherein the gas sensing element is an electrochemical gas sensor.

7. The gas sensing device of embodiment 6, wherein the gas sensing device has a maximum average power consumption of about 11 mWh.

8. The gas sensing device of embodiment 7, wherein the current source is a battery having a capacity of at least 342 watt-hours and a run time of at least 36 months.

9. The gas sensing device of embodiment 1, wherein the wireless communicator is a radio frequency module that wirelessly communicates with one or more external devices selected from the group consisting of: Wi-Fi/wireless, FM radio links, WPAN protocols, the Microsoft™ DirectBand network, Wibree™ WirelessHART, UWB, ISA-SP100 standards, Zigbee® IEEE 802.15.4-based protocols, the IEEE 802.11 family of WLAN protocols, and RFID signaling protocols.

10. The gas sensing device of embodiment 1, further comprising a display electrically connected to said processor, wherein the display periodically displays the gas concentration information and displays information communicated from the processor when the processor is activated by a user input command.

11. The gas sensing device of embodiment 1, further comprising at least one integrated user input module for entering user input commands.

12. The gas sensing device of embodiment 1, wherein the processor is a microprocessor which executes firmware that is programmed to perform a plurality of functions, including the steps of:

checking gas concentration information generated by the gas sensing element;

communicating gas concentration information to the wireless communicator;

checking a status of the current source;

responding to user input commands entered through an integrated user input module;

responding to external requests for information that are communicated to the device through the wireless communicator; and

directing the display of information related to any of said functions on a display.

13. The gas sensing device of embodiment 12, wherein said microprocessor executes each of the steps once per second.

14. A method for continuously monitoring the presence and/or concentration of at least one gas in a gaseous atmosphere with low power consumption, the method comprising the steps of:

providing a low power consumption gas sensing device, which device comprises a gas sensor module comprising a gas sensing element; a processor operably connected to the gas sensor module; a wireless communicator operably connected to said processor; and a current source electrically connected to each of the gas sensor module, the processor and the wireless communicator; wherein the gas sensing device has high power consumption active modes during which the processor actively communicates with integrated device components, a low power consumption passive mode during which the processor is inactive, and an off mode;

continuously monitoring the presence and/or concentration of said at least one gas in a gaseous atmosphere with said gas sensing element when the device is in either the active mode or the passive mode;

actively checking gas concentration information generated by the gas sensing element;

actively communicating said gas concentration information from the microprocessor to the wireless communicator; and

optionally wirelessly signaling an external alarm generating apparatus to produce an alarm.

15. The method of embodiment 14, wherein the gas sensing device communicates gas concentration information in real-time and wherein said microprocessor executes one or more of the steps once per second.

16. The method of embodiment 14, wherein the gas sensing element is a nondispersive infrared gas sensor.

17. The method of embodiment 16, wherein the gas sensing device consumes a maximum average power consumption of about 17 mWh.

18. The method of embodiment 14, wherein the gas sensing element is an electrochemical gas sensor.

19. The method of embodiment 18, wherein the gas sensing device consumes a maximum average power of about 11 mWh.

20. The method of embodiment 14, wherein the wireless communicator is a radio frequency module that wirelessly communicates with one or more external devices up to once per second.

Thus, in accordance with one aspect of the disclosure, a gas sensing device 10 or 100 having high power consumption active modes, a low power consumption passive mode and an off mode is provided. The gas sensing device includes a gas sensor module 12 having a gas sensing element. The gas sensing element continuously monitors at least one of the presence and concentration of at least one gas in a gaseous atmosphere during the active modes and the passive mode, and continuously generates corresponding gas concentration information. The gas sensor also includes a wireless communicator 16 and a processor 14 operably connected to the gas sensor module 12 and the wireless communicator 16. The processor 14 is configured to actively communicate during the active modes, be inactive when in the low power consumption passive mode, retrieve the gas concentration information from the gas sensor module, and transmit the information to the wireless communicator 16. The gas sensing device also includes a power supply 18 electrically connected to each of the gas sensor module 12, the processor 14 and the wireless communicator 16. The wireless communicator 16 is configured to receive the gas concentration information from the processor 14 and to wirelessly transmit the information to at least one information receiver.

In one embodiment of this aspect, the gas concentration information is real-time gas concentration information. In another embodiment of this aspect, the gas sensing element is a nondispersive infrared gas sensor. In still another embodiment of this aspect, the gas sensing device has a maximum average power consumption of about 17 mWh. In yet another embodiment of this aspect, the power supply is a battery having a capacity of at least 342 watt-hours and a run time of at least 24 months.

In another embodiment of this aspect, the gas sensing element is an electrochemical gas sensor. In still another embodiment of this aspect, the gas sensing device has a maximum average power consumption of about 11 mWh. In still yet another embodiment of this aspect, the power supply is a battery having a capacity of at least 342 watt-hours and a run time of at least 36 months.

In another embodiment of this aspect, the wireless communicator 16 is a radio frequency module that wirelessly communicates with at least one external device selected from the group consisting of Wi-Fi/wireless; FM radio links; wireless personal area network, WPAN, protocols; Microsoft™ DirectB and network; Wibree™; WirelessHART; Ultra-wideband, UWB; ISA-SP100 standards; Zigbee®; IEEE 802.15.4-based protocols; IEEE 802.11 family of WLAN protocols; and RFID signaling protocols. In still another embodiment of this aspect, a display 20 is electrically connected to the processor 16 in which the display 20 periodically displays the gas concentration information and displays information communicated from the processor 16 when the processor 16 is activated by a user input command In another embodiment of this aspect, the gas sensing device further includes at least one integrated user input module for entering user input commands.

In still another embodiment of this aspect, the processor 14 is configured to execute firmware 36 that is programmed to perform a plurality of functions. The functions include checking gas concentration information generated by the gas sensing element, communicating gas concentration information to the wireless communicator; checking a status of the power supply, responding to user input commands entered through an integrated user input module, responding to external requests for information that are communicated to the device through the wireless communicator and directing the display of information related to any of said functions on a display. In accordance with another embodiment of this aspect, the processor executes each of the functions once per second.

In accordance with another aspect, a method for continuously monitoring at least one of the presence and concentration of at least one gas in a gaseous atmosphere is provided. The method includes providing a gas sensing device 10 or 100 configured for operation in high power consumption active modes, a low power consumption passive mode and an off mode (block S100). The provided device has a gas sensor module 12 comprising a gas sensing element, a processor 14 operably connected to the gas sensor module, a wireless communicator 16 operably connected to the processor and a power supply 18 electrically connected to each of the gas sensor module 12, the processor 14 and the wireless communicator 16. The processor 14 is configured to actively communicate during the active modes and be inactive when in the low power consumption passive mode. The method further includes continuously monitoring at least one of the presence and concentration of the at least one gas in a gaseous atmosphere with the gas sensing element when the device is in the active mode or the passive mode (block S102), actively checking gas concentration information generated by the gas sensing element (block S104) and actively communicating the gas concentration information from the processor 14 to the wireless communicator 16 (block S106).

In an embodiment of this aspect, the gas sensing device 10 or 100 communicates gas concentration information in real-time, and the processor 14 executes at least one of the continuously monitoring, actively checking and actively communicating steps once per second.

In another embodiment of this aspect, the gas sensing element is a nondispersive infrared gas sensor. In still another embodiment of this aspect the gas sensing device consumes a maximum average power consumption of about 17 mWh.

In yet another embodiment of this aspect, the gas sensing element is an electrochemical gas sensor. In still another embodiment of this aspect, the gas sensing device consumes a maximum average power of about 11 mWh. In another embodiment of this aspect, the wireless communicator 16 is a radio frequency module that wirelessly communicates with at least one external device up to once per second. In another embodiment of this aspect, the method further includes wirelessly signaling an external alarm generating apparatus to produce an alarm.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A gas sensing device having high power consumption active modes, a low power consumption passive mode and an off mode, the gas sensing device comprising:
a gas sensor module comprising a gas sensing element, the gas sensing element continuously monitoring at least one of the presence and concentration of at least one gas in a gaseous atmosphere during the active modes and the passive mode, and continuously generating corresponding gas concentration information;
a wireless communicator;
a processor operably connected to the gas sensor module and the wireless communicator, the processor configured to:
actively communicate during the active modes;
be inactive when in the low power consumption passive mode; and
retrieve the gas concentration information from the gas sensor module and to transmit the information to the wireless communicator;
a power supply electrically connected to each of the gas sensor module, the processor and the wireless communicator; and
the wireless communicator being configured to receive the gas concentration information from the processor and to wirelessly transmit the information to at least one information receiver.

2. The gas sensing device of claim 1, wherein the gas concentration information is real-time gas concentration information.

3. The gas sensing device of claim 1, wherein the gas sensing element is a nondispersive infrared gas sensor.

4. The gas sensing device of claim 3, wherein the gas sensing device has a maximum average power consumption of about 17 mWh.

5. The gas sensing device of claim 4, wherein the power supply is a battery having a capacity of at least 342 watt-hours and a run time of at least 24 months.

6. The gas sensing device of claim 1, wherein the gas sensing element is an electrochemical gas sensor.

7. The gas sensing device of claim 6, wherein the gas sensing device has a maximum average power consumption of about 11 mWh.

8. The gas sensing device of claim 7, wherein the power supply is a battery having a capacity of at least 342 watt-hours and a run time of at least 36 months.

9. The gas sensing device of claim 1, wherein the wireless communicator is a radio frequency module that wirelessly communicates with at least one external device selected from the group consisting of Wi-Fi/wireless; FM radio links; wireless personal area network, WPAN, protocols; Microsoft™ DirectBand network; Wibree™; WirelessHART; Ultra-wideband, UWB; ISA-SP100 standards; Zigbee®; IEEE 802.15.4-based protocols; IEEE 802.11 family of WLAN protocols; and RFID signaling protocols.

10. The gas sensing device of claim 1, further comprising a display electrically connected to the processor, wherein the display periodically displays the gas concentration information and displays information communicated from the processor when the processor is activated by a user input command.

11. The gas sensing device of claim 1, further comprising at least one integrated user input module for entering user input commands.

12. The gas sensing device of claim 1, wherein the processor is configured to execute firmware that is programmed to perform a plurality of functions, the functions including:
checking gas concentration information generated by the gas sensing element;
communicating gas concentration information to the wireless communicator;
checking a status of the power supply;
responding to user input commands entered through an integrated user input module;
responding to external requests for information that are communicated to the device through the wireless communicator; and
directing the display of information related to any of said functions on a display.

13. The gas sensing device of claim 12, wherein the processor executes each of the functions once per second.

14. A method for continuously monitoring at least one of the presence and concentration of at least one gas in a gaseous atmosphere, the method comprising the steps of:
providing a gas sensing device configured for operation in high power consumption active modes, a low power consumption passive mode and an off mode, the device having:
a gas sensor module comprising a gas sensing element;
a processor operably connected to the gas sensor module;
a wireless communicator operably connected to the processor; and
a power supply electrically connected to each of the gas sensor module, the processor and the wireless communicator;
the processor configured to:
actively communicate during the active modes; and
be inactive when in the low power consumption passive mode;
continuously monitoring at least one of the presence and concentration of the at least one gas in a gaseous atmosphere with the gas sensing element when the device is in the active mode or the passive mode;
actively checking gas concentration information generated by the gas sensing element; and
actively communicating the gas concentration information from the processor to the wireless communicator.

15. The method of claim 14, wherein the gas sensing device communicates gas concentration information in real-time, and wherein the processor executes at least one of the continuously monitoring, actively checking and actively communicating steps once per second.

16. The method of claim 14, wherein the gas sensing element is a nondispersive infrared gas sensor.

17. The method of claim 16, wherein the gas sensing device consumes a maximum average power consumption of about 17 mWh.

18. The method of claim 14, wherein the gas sensing element is an electrochemical gas sensor.

19. The method of claim 18, wherein the gas sensing device consumes a maximum average power of about 11 mWh.

20. The method of claim 14, wherein the wireless communicator is a radio frequency module that wirelessly communicates with at least one external device up to once per second.

21. The method of claim 14, further comprising wirelessly signaling an external alarm generating apparatus to produce an alarm.
